(19) United States
(12) Patent Application Publication
(10) Pub. No.: US 2022/0314236 A1
(43) Pub. Date: Oct. 6, 2022

(54) ELECTRIC FIELD PARTICLE COLLECTION DEVICE

(71) Applicant: XIDAS, INC., Irvine, CA (US)

(72) Inventors: Mark Bachman, Irvine, CA (US); Philip N. Duncan, Irvine, CA (US)

(21) Appl. No.: 17/712,580

(22) Filed: Apr. 4, 2022

Related U.S. Application Data
(60) Provisional application No. 63/170,762, filed on Apr. 5, 2021.

(51) Int. Cl. B03C 5/00

(52) U.S. Cl. CPC B03C 5/005; B03C 2201/26

(57) ABSTRACT

This invention describes a device to collect a subset of small particles, such as cells, utilizing one or more electric fields formed by conductors attached to an insulating structure. The invention utilizes one or more conducting materials which are connected to a voltage source to generate the electric fields. The conductors are placed in a liquid sample containing one or more populations of particles. Some of the particles may be attracted to or repelled from the conductors due to the electric fields. If attracted, the particles attach to the conductors, after which, the conductors are removed from the sample and placed into a second sample to collect the particles. Particles that are attracted to the conductors may be drawn into a cavity or tube via suction. Alternatively, particles that are repelled by the electric field are preferentially excluded from being drawn into a suction cavity placed near the conductors.

### CROSS-REFERENCES TO RELATED APPLICATIONS

This application is a non-provisional and claims benefit of U.S. Provisional Application No. 63/170,762 filed Apr. 5, 2021, the specification of which is incorporated herein in its entirety by reference.

### BACKGROUND OF THE INVENTION

There is often a need to separate a subset of small particles or cells from a heterogeneous sample of different types of particles or cells. This is often the case when one needs a few particles or cells to study, or one needs a sample enriched with a certain population of particles or cells. Electric fields are often used for separating particles from a heterogeneous liquid media sample. Examples are electrophoresis and dielectrophoresis which separate particles based on charge or dipole moment or dielectric property. Using electric fields, one may attract or repel a subset of the particles depending on their response to the electric fields.

Electrophoresis is often used in biological assays for separating large molecules such as proteins and DNA based on their charge to size ratio. In these assays, the electrodes are embedded within a gel and the particles are separated by their drift time through the gel as they migrate to the electrodes. Dielectrophoresis is sometimes used in biological assays utilizing small fluidic systems to separate small cells by their polarization properties. In these assays, particles that are drawn to or repelled from electrodes are separated by flow streams that go to different outlets.

In both of these assays, considerable preparation work is needed to set up the assay and create the proper conditions to sort the particles. In particular, small volume flow systems are difficult to set up and require carefully moving the sample through small tubes and flow devices.

There would be a benefit to being able to insert a probe or device into a liquid sample and immediately collect the particles of interest. In the simplest embodiment, the probe would collect the particles or cells, then be transferred to a second container to wash them off the probe. Other embodiments can be envisioned that increase the throughput of this process.

### BRIEF SUMMARY OF THE INVENTION

It is an objective of the present invention to provide systems, devices, and methods that allow for collecting particles in a solution by using electric fields, as specified in the independent claims. Embodiments of the invention are given in the dependent claims. Embodiments of the present invention can be freely combined with each other if they are not mutually exclusive.

The key unique feature of this invention is a probe and the use of one or more electrical conductors to create an electric field that can be used to attract or repel particles near the probe. This allows one to selectively collect those particles that are attached to or near the probe. This invention does not require flowing fluid.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

The features and advantages of the present invention will become apparent from a consideration of the following detailed description presented in connection with the accompanying drawings in which:

FIG. 1 shows an embodiment of the present invention, indicating the presence of two conductors (102) held by an insulating structure (104) that is immersed in a liquid to gather particles or cells. The conductors (102) are exposed at the distal end of the insulating structure (104), and a connection to an electrical circuit is made at the other side (106).

FIG. 2 shows an embodiment of the present invention that utilizes small cavities in the probe to collect particles. In this embodiment, small cavities (203) are added to the insulating structure (204) to facilitate the collection of particles. Cavities and irregular structures may also be imparted to the conducting surfaces. When the probe is removed from the liquid, the cavities hold liquid in their recesses, typically through surface tension (208).

FIG. 3 shows an embodiment of the present invention that utilizes a small tube (310) in the probe to collect particles continuously. In this embodiment, a small tube (310) is placed in the insulating structure (304) with one opening at or near the distal end of the insulating structure (304) and a second opening at a convenient location that is not near the distal end of the insulating structure (304). When the one or more conducting wires (302) are in the liquid sample, suction is placed on the tube (310) causing local flow (320) of liquid into the tube (310) at the probe end. Particles that are drawn to the one or more conducting wires (302) by the electric fields are subsequently drawn into the tube (310) by the local flow (320). Conversely, particles that are repelled by the electric fields are excluded from being drawn into the tube.

FIG. 4 shows a method for using the present invention to remove a subset of particles or cells from a sample and disperse them into a second sample. FIG. 4 shows how the simplest embodiment is used to collect small particles (130) from a liquid sample (110). The device (100) is inserted into a sample containing particles to be collected. An electric field is generated across the conductors (102) which causes some of the particles (130) to be attracted to the conductors (102). The device (100) is removed from the sample (110) with particles and residual liquid (115) still attached to the conductors. The probe is then moved to a second liquid sample (120). The electric fields are turned off and the sample fluid washes the particles (130) off the conductors (102). The probe is removed from the second sample (120) and the particles are then left in the second sample (120).

FIG. 5 shows an illustration of a typical electric field formed by two conducting wires, showing field lines and the presence of different particles that may respond to the electric fields. FIG. 5 shows a cross-section of two conducting wires (102) and the typical electric field (108) that is created when a voltage difference is placed between the wires. Also shown are representative particles (130) that may respond to the electric field. If the particles have a net charge, they will be attracted to one of the conductors. If the particles have a net polarization, they will be attracted by the field gradient.

FIG. 6 shows the typical use of a small flow system to separate particles or cells using electric fields. This is a representative flow system designed to collect charged or polarized particles, representing the current state of the art. In this system, a heterogeneous sample of particles (602) is placed in a fluid flow stream (604) near one or more conductors (606) placed in the flow stream. Particles that are attracted to the conductors move to a separate laminar flow stream that flows to a separate outlet (608) for collection.

### DETAILED DESCRIPTION OF THE INVENTION

Following is a list of elements corresponding to a particular element referred to herein:
100 particle collecting device
102 one or more conductors
104 structural element
106 one or more leads
108 electric field
110 first sample
115 residual liquid
120 second sample
130 particles
200 particle collecting device
202 one or more conductors
203 small cavity
204 insulating structure
208 surface tension
300 particle collection device
302 one or more conductors
304 insulating structure
310 tube
320 local flow
602 sample of particles
604 fluid flow stream
606 one or more conductors
608 outlet

In some embodiments, this present invention describes a device for collecting a subset of small particles, such as cells, utilizing one or more electric fields formed by conductors attached to an insulating mechanical structure. It utilizes one or more conducting materials such as wires, tubes, or electrodes which are connected to a voltage source, to generate the electric fields. The electrical conductors are placed in a solution containing one or more populations of particles. Under appropriate conditions, some of the particles may be attracted to or repelled from the conductors due to the electric fields. If attracted, the particles may attach to the conductors, after which, the conductors may be removed from the sample and placed into a second sample to collect the particles by washing them off. Alternatively, the particles which are attracted to the conductors may be drawn into a cavity through the use of suction to collect them. Alternatively, the particles that are repelled by the electric field may be preferentially excluded from being drawn into a suction cavity placed near the conductors. Alternatively, the collection cavity may be connected to tubing to continuously draw the selected particles from the sample solution.

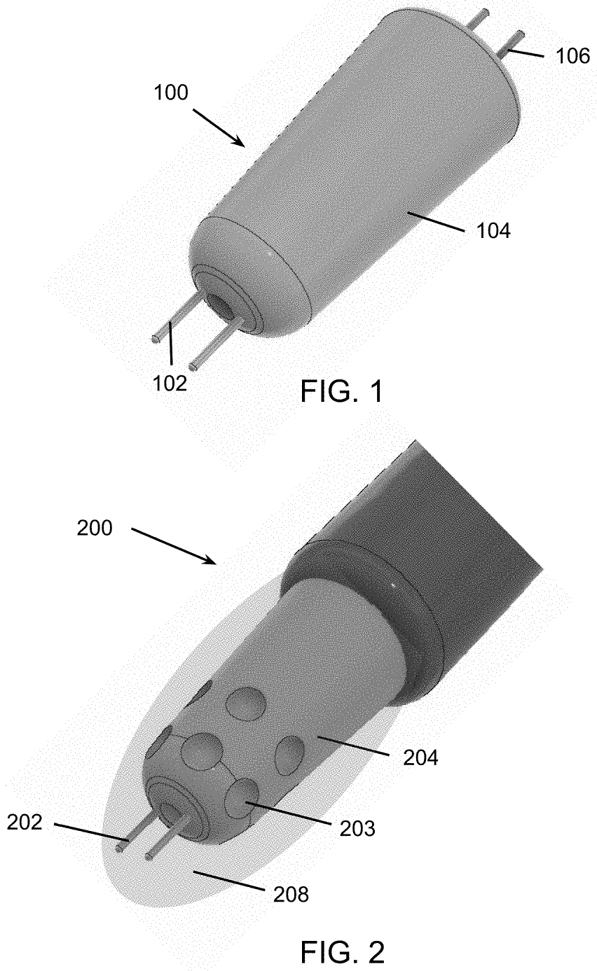

FIG. 1 shows a non-limiting embodiment of the current invention. In this embodiment, the present invention features a device (100) for collecting particles. In some embodiments, the device (100) comprises a structural element (104) and one or more conductors (102), and one or more leads (106). In other embodiments, the one or more conductors (102) and the one or more leads (106) are disposed at opposing ends of the structural element (104). In yet another embodiment, the one or more conductors (102) are connected to the one or more leads (106). In preferred embodiments, two conducting wires (102) are built into the structural element (104). The conducting wires (102) are exposed at the distal end of the structural element (104), and a connection to an electrical circuit is made at the other side. In this configuration, the conducting wires (102) are within about 1 mm of each other. This may allow for the attraction or repulsion of particles in a sample fluid through use of a conductor without the need for a flow stream.

In some embodiments, the structural element (104) is made out of an insulating material or is an insulating probe. Non-limiting examples of particles include animal cells or plant cells. In some embodiments, any particle that is responsive to the electric field generated by the one or more conductors (e.g. solid organic or composite particles, proteins, viruses) may be used. In some embodiments, the particles are smaller than about 1 mm. In other embodiments, the sample is an aqueous solution. In some embodiments, the sample may comprise manufacturing, agricultural or industrial products, etc.

An alternate embodiment of the present invention is shown in FIG. 2. In this embodiment, the device (200) comprises one or more conductors (202) disposed at a distal end of an insulating structure (204) and cavities (203) are disposed on the insulating structure (204). Without wishing to limit the present invention to any theory or mechanism, the cavities (203) are added to the insulating structure (204) to facilitate collection of the particles. In further embodiments, cavities (203) or irregular structures may also be imparted to the conducting surfaces. When the insulating structure is removed from liquid the cavities hold liquid in their recesses, typically through surface tension (208). Cavities or irregular structures disposed on the surface of the insulating element and/or the conductors facilitate better holding of the particles and facilitates holding of the liquid during transfer. In some embodiments, particles may be contained on both the one or more conductors and the one or more cavities in the form of particles attracted to the electric field of the conductors and liquid containing the particles being held in the cavities.

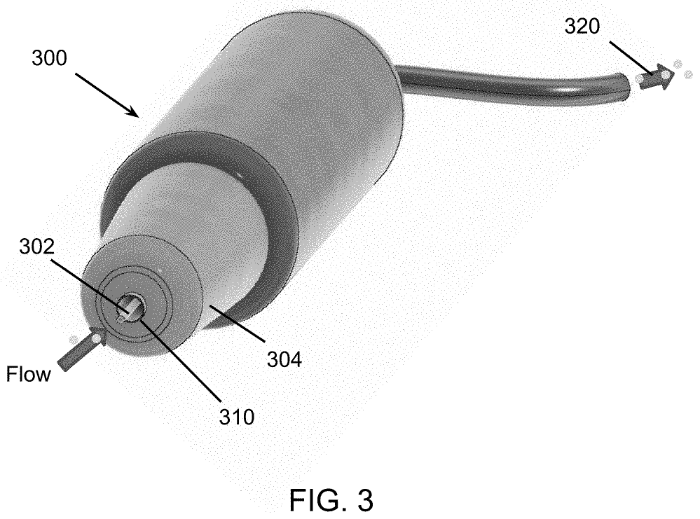

FIG. 3 shows an alternative embodiment of the present invention that utilizes a small tube in the device (300) to collect particles continuously. In this embodiment, a small tube (310) is placed in the insulating structure (304) with one opening at or near the distal end of the insulating structure and a second opening at a convenient location that is not near the distal end of the insulating structure. When the device is in the liquid sample, suction is placed on the tube causing local flow of liquid into the tube (310) at the device end. Particles that are drawn to the conductors (302) by the electric fields are subsequently drawn into the tube (310) by the local flow (320). Conversely, particles that are repelled by the electric fields are excluded from being drawn into the tube (310).

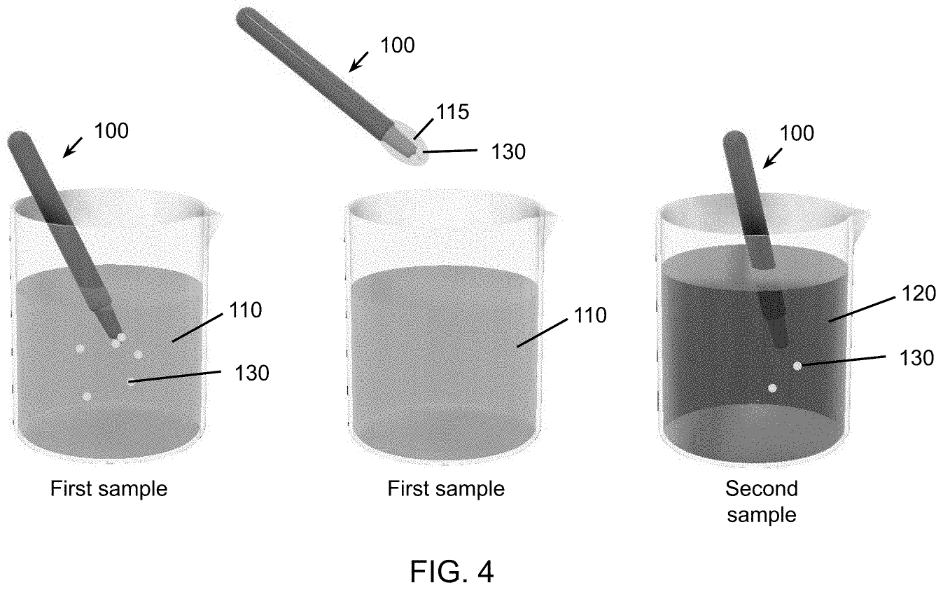

FIG. 4 shows how the embodiment of FIG. 1 is used to collect small particles from a liquid sample. The device (100) with attached electrodes (102) is inserted into a sample containing particles (130) to be collected. An electric field is generated across the conductors which causes some of the particles to be attracted to the electrodes. The device (100) is removed from the sample with particles and residual liquid (115) still attached to the conductors. The device (100) is then moved to a second liquid sample (120). The electric fields are turned off and the sample fluid washes the particles off the conductors. The device (100) is removed from the second sample and the particles are then left in the sample.

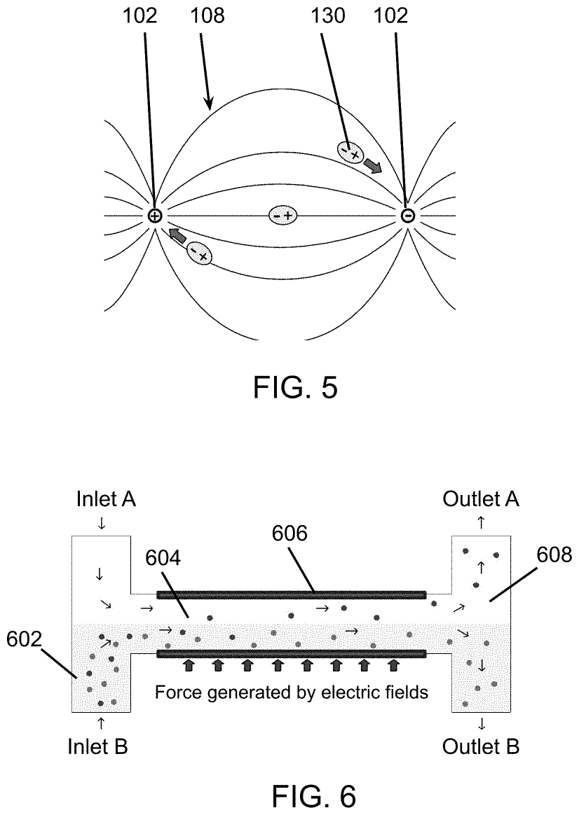

FIG. 5 shows a cross-section of two conducting wires (102) and the typical electric field (108) that is created when a voltage difference is placed between the wires (102). Also shown are representative particles (130) that may respond to the electric field. The voltage difference generates an electric field which induces the dielectric response of the particle and the movement of the particle along the field. If the particles have a net charge, they will be attracted by one of the conductors. If the particles have a net polarization, they will be attracted by the field gradient.

FIG. 6 shows a representative flow system designed to collect charged or polarized particles, representing the current state of the art. In this system, a heterogeneous sample of particles (602) is placed in a fluid flow stream (604) near one or more conductors (606) placed in the flow stream. Particles that are attracted to the conductors move to a separate laminar flow stream that flows to a separate outlet (608) for collection. In yet another embodiment, any of the devices described herein may be modified to use electronics and power encased in the device to generate electric fields on the conductors without the need for an external cable.

In other embodiments, the present invention features a method for collecting particles using any of the devices described herein. The method comprises submerging the one or more conductors (102) in a sample comprising particles and applying an electric current to the one or more leads (106) to generate an electric field at the one or more conductors (102). Without wishing to limit the present invention to any theories or mechanisms, the particles are attracted by the electric field and are collected at the one or more conductors (102). In further embodiments, the method further comprises removing the one or more conductors (102) from the sample to transfer the particles to a second container.

As non-limiting examples, the insulating material of the present invention may comprise polymers such as polytetrafluoroethylene, polymethylmethacrylate, polycarbonate, polyethylene, epoxies, silicones, latex, rubber, ceramics, glasses, quartz, porcelain, etc.

The device described in this disclosure may be constructed for manual operation, automated operation using external machinery, and flow-through operation to collect small particles and cells from a heterogeneous sample.

The present invention features a method for collecting particles using the device (100). In some embodiments, the method may comprise submerging the one or more conductors (102) in a sample comprising particles, and applying an electric current to the one or more leads (106) to generate an electric field at the one or more conductors (102). In some embodiments, the particles may be repelled by the electric field and may be collected by the device (102) using a flow stream. In other embodiments, the particles may be repelled by the electric field and may be collected using a physical structure, such as a mesh or cavity.

As used herein, the term “about” refers to plus or minus 10% of the referenced number. Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A device (100) for collecting particles, the device comprising:
a. a structural element (104); and
b. one or more conductors (102) and one or more leads (106), wherein the one or more conductors (102) are connected to the one or more leads (106);
wherein the one or more conductors (102) are configured to generate an electrical field such that one or more of the particles are attracted by the electric field and are collected or repelled by the one or more conductors (102) without a flow stream.

2. The device (100) of claim 1, wherein the structural element is made of an insulating material.

3. The device (100) of claim 1, wherein the one or more conductors (102) are wires, conductive tubes, or electrodes.

4. The device (100) of claim 1, wherein the one or more conductors (102) and the one or more leads (106) are disposed at opposing ends of the structural element (104).

5. The device (100) of claim 1, wherein cavities (203) are disposed on the structural element (104).

6. The device (100) of claim 1, wherein cavities (203) are disposed on the one or more conductors (102).

7. The device (100) of claim 1, wherein device (100) further comprises a tube (310) disposed within the structural element (104).

8. The device (100) of claim 7, wherein suction is applied to the tube (310) to collect particles.

9. The device (100) of claim 1, wherein the particles are cells.

10. The device (100) of claim 1, wherein the particles are smaller than about 1 mm.

11. The device (100) of claim 1, wherein the sample is an aqueous solution.

12. The device (100) of claim 1, wherein one or more particles are repelled by the electric field.

13. The device (100) of claim 12 further comprising a suction component disposed separately from the structural component (104), wherein the one or more particles repelled by the electric field are collected by the suction component.

14. A method for collecting particles using the device (100) of claim 1, the method comprising:
a. submerging the one or more conductors (102) in a sample comprising particles; and
b. applying an electric current to the one or more leads (106) to generate an electric field at the one or more conductors (102);
wherein the particles are attracted by the electric field and are collected at the one or more conductors (102) without a flow stream.

15. The method of claim 14, wherein the method further comprises removing the one or more conductors (102) from the sample to transfer the particles to a second container.

16. The method of claim 14, wherein cavities (203) are disposed on the one or more conductors (102).

17. The method of claim 14, wherein the device (100) further comprises a tube (310) disposed within the structural element (104).

18. The method of claim 17, wherein suction is applied to the tube (310) to collect particles.

19. The method of claim 14, wherein the particles are cells.

20. The method of claim 14, wherein the particles are smaller than about 1 mm.

21. A method for collecting particles using the device (100) of claim 1, the method comprising:
a. submerging the one or more conductors (102) in a sample comprising particles; and
b. applying an electric current to the one or more leads (106) to generate an electric field at the one or more conductors (102);
wherein the particles are repelled by the electric field and are collected by the device (102) using a flow stream.

22. The method of claim 21 where the particles are additionally repelled by the electric field and are collected using a physical structure, such as a mesh or cavity.
